(19) United States
(12) Patent Application Publication
(10) Pub. No.: US 2026/0237821 A1
(43) Pub. Date: Aug. 13, 2026

(54) LOADING AND UNLOADING SYSTEM AND METHOD FOR ENERGY STORAGE SYSTEMS

(71) Applicant: Fluence Energy, LLC, Arlington, VA (US)

(72) Inventors: Hariram Patel, Bangalore (IN); Karthik Ramesh, Coimbatore (IN); Srikanth Rajan Karayil, Chennai (IN)

(73) Assignee: Fluence Energy, LLC, Arlington, VA (US)

(21) Appl. No.: 19/529,219

(22) Filed: Feb. 4, 2026

Related U.S. Application Data
(60) Provisional application No. 63/754,246, filed on Feb. 5, 2025.

(51) Int. Cl. H01M 50/244; H01M 50/251; H01M 50/264

(52) U.S. Cl. CPC H01M 50/244; H01M 50/251; H01M 50/264

(57) ABSTRACT

A loading/unloading system for an energy storage system enclosure includes: a skate channel weldment having a U-shape, a pair of guide wheels arranged at a rear end of the skate channel weldment, a plurality of jack mounts arranged adjacent to a top side of the skate channel weldment, a plurality of hydraulic jacks arranged within the plurality of jack mounts, a plurality of skate assemblies arranged adjacent to a bottom side of the skate channel weldment, and a plurality of jack lugs each of which includes a jack resting portion, and an enclosure attachment portion. The plurality of hydraulic jacks moveable from a retracted position to an extended position via a hydraulic pump, to raise and lower the energy storage system enclosure for loading/unloading to/from a standard shipping container.

### CROSS-REFERENCE TO RELATED APPLICATIONS

This application claims the benefit of U.S. Provisional Application Number 63/754,246, filed on February 5, 2025, which is hereby incorporated by reference in its entirety.

### INTRODUCTION

The concepts described herein relate generally to energy storage systems, and more specifically, to a loading/unloading system for loading and unloading a modular energy storage system enclosure having an increased storage capacity to and from a standard shipping container.

Modular energy storage systems include multiple individual energy storage system enclosures interconnected to provide larger modular energy storage system enclosures having varied levels of increased storage capacity. The larger modular energy storage system enclosures can be used to store greater amounts of additional power produced by an external power source during periods of reduced demand and provide that greater amount of stored power to external power sources during periods of increased demand.

As demand for energy storage system enclosures having greater storage capacity increases, the overall size and weight of the modular energy storage system enclosure increases respectively. As the overall size and weight of the modular energy storage system enclosure increases, loading and unloading the modular energy storage enclosure into and out of a standard shipping container becomes challenging, and, at times, simply not possible using conventional loading and unloading methods. Instead requiring transport via more expensive methods including, for example, non-standard open top and/or flat rack shipping containers, both of which are more expensive and less readily available.

As such, it would be advantageous to provide a loading/unloading system that facilitates the loading and unloading of a modular energy storage system enclosure having increased storage capacity to and from a standard shipping container for transport via ocean freight.

### SUMMARY

In view of the above discussion, it is useful to develop to provide a loading/unloading system that facilitates the loading and unloading of a modular energy storage system enclosure having increased storage capacity to and from a standard shipping container, for example, a standard 40 foot high-capacity (HC) shipping container, for transport via ocean freight.

The concepts disclosed herein relate to a loading/unloading system for loading and/or unloading an energy storage system enclosure to and from a standard shipping container for transport via ocean freight.

A loading/unloading system for an energy storage system enclosure may include a skate channel weldment, a first plurality of jack mounts, a second plurality of jack mounts, a first plurality of hydraulic jacks, a second plurality of hydraulic jacks, a first plurality of skate assemblies, a second plurality of skate assemblies, and a plurality of jack lugs.

The skate channel weldment may include a front portion having a first end portion and a second end portion, a first side portion and a second side portion.

The first side portion may have a first top side, a first bottom side, a first front end, and a first rear end. The first front end of the first side portion may be arranged adjacent to the first end portion of the front portion.

The second side portion may have a second top side, a second bottom side, a second front end, and a second rear end. The second front end of the second side portion may be arranged adjacent to the second end portion of the front portion.

The first plurality of jack mounts may include a first jack mount and a second jack mount arranged adjacent to the first top side of the first side portion.

The second plurality of jack mounts may include a third jack mount and a fourth jack mount arranged adjacent to the second top side of the second side portion.

The first plurality of hydraulic jacks may be disposed within the first plurality of jack mounts.

The second plurality of hydraulic jacks may be disposed within the second plurality of jack mounts.

The first plurality of skate assemblies may be arranged adjacent to the first bottom side of the first side portion, and the second plurality of skate assemblies may be arranged adjacent to the second bottom side of the second side portion.

Each of the plurality of jacks may include a jack resting portion, and an enclosure attachment portion.

According to one aspect of the disclosure, the front portion, the first side portion, and the second side portion of the skate channel weldment may define a U-shape.

According to one aspect of the disclosure, each of the front portion, the first side portion, and the second side portion may include a U-channel.

The loading/unloading system may further include a first wheel assembly arranged at the first rear end of the first side portion of the skate channel weldment, and a second wheel assembly arranged at the second rear end of the second side portion of the skate channel weldment.

The loading/unloading system may further include a first plurality of skate mounts formed in the first bottom side of the first side portion of the skate channel weldment, and a second plurality of skate mounts formed in the second bottom side of the second side portion of the skate channel weldment.

Each of the first plurality of skate assemblies may be arranged within a respective one of the first plurality of skate mounts, and each of the second plurality of skate assemblies may be arranged within a respective one of the second plurality of skate mounts.

The loading/unloading system may further include a first guiding channel extending from the front portion of the skate channel weldment, and a second guiding channel extending from the front portion of the skate channel weldment.

The first guiding channel may be arranged adjacent to a first inside surface of the first side portion, and the second guiding channel may be arranged adjacent to a second inside surface of the second side portion.

Each of the plurality of jack lugs may include an opening arranged in the enclosure attachment portion for attachment to a bottom corner casting of the energy storage system enclosure via a fastener, which may include, for example a bolt 313A and a nut 313B.

A hydraulic pump system may be in hydraulic communication with each of the first plurality of hydraulic jacks and each of the second plurality of hydraulic jacks.

The hydraulic pump system may be operable to raise the first plurality of hydraulic jacks and the second plurality of hydraulic jacks from a retracted position to an extended position, and lower the first plurality of hydraulic jacks from the extended position to the retracted position.

According to another aspect of the disclosure, a loading/unloading system for an energy storage system enclosure may include a skate channel weldment having a U-shape, a pair of guide wheels arranged at a rear end of the skate channel weldment, a plurality of jack mounts arranged adjacent to a top side of the skate channel weldment, a plurality of hydraulic jacks arranged within the plurality of jack mounts, a plurality of skate assemblies arranged adjacent to a bottom side of the skate channel weldment, and a plurality of jack lugs.

Each of the plurality of jack lugs may include a jack resting portion, and an enclosure attachment portion, and each of the plurality of hydraulic jacks may be moveable between a retracted position and an extended position.

According to another aspect of the disclosure, a method of loading/unloading an energy storage system enclosure may include: providing a loading/unloading system for an energy storage system enclosure; aligning the loading/unloading system within markings on a platform adjacent to a shipping container floor; lifting the energy storage system enclosure via a plurality of lifting lugs, each of which is attached to a respective one of a plurality of top corner castings attached to the energy storage system enclosure; positioning the energy storage system enclosure above the loading/unloading system; attaching each of the plurality of jack lugs to a respective one of a plurality of bottom corner castings attached to the energy storage system enclosure; adjusting the loading/unloading system such that each of the plurality of jack lugs is positioned above a respective one of the plurality of hydraulic jacks; lowering the energy storage system enclosure onto the loading/unloading system; activating the hydraulic pump system to engage the plurality of hydraulic jacks to raise the energy storage system enclosure above the platform; moving the loading/unloading system, including the energy storage system enclosure, forward toward a front of the shipping container until the energy storage system enclosure is centered within the shipping container; and activating a hydraulic pump system to disengage the plurality of hydraulic jacks to lower the energy storage system enclosure onto dunnage within the shipping container.

The loading/unloading system may include a skate channel weldment having a U-shape, a pair of guide wheels arranged at a rear end of the skate channel weldment, a plurality of jack mounts arranged adjacent to a top side of the skate channel weldment, a plurality of hydraulic jacks arranged within the plurality of jack mounts, a plurality of skate assemblies arranged adjacent to a bottom side of the skate channel weldment, a plurality of jack lugs, and a hydraulic pump system in hydraulic communication with each of the plurality of hydraulic jacks.

Each of the plurality of jack lugs may include a jack resting portion, and an enclosure attachment portion.

Lifting the energy storage system enclosure may include attaching steel cables to the lifting lugs, and lifting the energy storage system enclosure via the steel cables using a crane.

The method of loading/unloading an energy storage system enclosure may further include leveling a top surface of the platform to be coplanar with a top surface of a floor of the shipping container.

The pair of guide wheels may guide the loading/unloading system within the shipping container when the loading/unloading system, including the energy storage system enclosure, may be moving forward toward the front of the shipping container.

The method of loading/unloading an energy storage system enclosure may further include positioning two rectangular steel channels within the shipping container such that each of the pair guide wheels engages with a respective one of the two rectangular steel channels to guide the loading/unloading system within the shipping container.

According to one aspect of the disclosure, the hydraulic pump system may be activated to engage the plurality of hydraulic jacks to raise the energy storage system enclosure up to 15 millimeters above the top surface of the platform.

According to one aspect of the disclosure, the loading/unloading system, including the energy storage system enclosure, may be moved using a forklift.

According to one aspect of the disclosure, the method of loading/unloading an energy storage system enclosure may include removing the loading/unloading system from the shipping container using a forklift.

According to one aspect of the disclosure, the plurality of jack lugs may remain attached to the energy storage system enclosure during shipping.

According to another aspect of the disclosure, the plurality of jack lugs is removed from the energy storage system enclosure prior to shipping.

By providing a loading/unloading system that facilitates the loading and unloading of a modular energy storage system enclosure having increased storage capacity to and from a standard shipping container for transport via ocean freight, utilization of more expensive methods of transport including, for example, non-standard open top and/or flat rack shipping containers, both of which are more expensive and less readily available, may be minimized and/or avoided.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1A schematically illustrates an isometric top view of a modular energy storage system including an energy storage system enclosure.

FIG. 1B schematically illustrates an isometric bottom view of a modular energy storage system including an energy storage system enclosure.

FIG. 2 schematically illustrates a loading/unloading system in accordance with one aspect of the disclosure.

FIG. 2A schematically illustrates one of a plurality of jack lugs in accordance with the present disclosure.

FIG. 3 schematically illustrates a loading/unloading system including a hydraulic pump and hydraulic lines in accordance with one aspect of the disclosure.

FIG. 4A schematically illustrates a loading/unloading system including a plurality of hydraulic jacks in a retracted position in accordance with the present disclosure.

FIG. 4B schematically illustrates a loading/unloading system including a plurality of hydraulic jacks in an extended position in accordance with the present disclosure.

FIG. 5 schematically illustrates loading/unloading an energy storage system enclosure using a loading/unloading system in accordance with the present disclosure.

FIG. 6 illustrates a method of loading/unloading an energy storage system enclosure using a loading/unloading system in accordance with the present disclosure.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The present disclosure is susceptible of embodiment in many different forms. Representative examples of the disclosure are shown in the drawings and described herein in detail as non-limiting examples of the disclosed principles. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, the term “system” refers to mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As employed herein, terms such as "vertical", "horizontal", "left", "right", “upper”, “lower”, “top”, “bottom” and similar expressions are non-limiting terms that merely describe the various elements as illustrated in the Figures and are not intended to limit the scope of the disclosure.

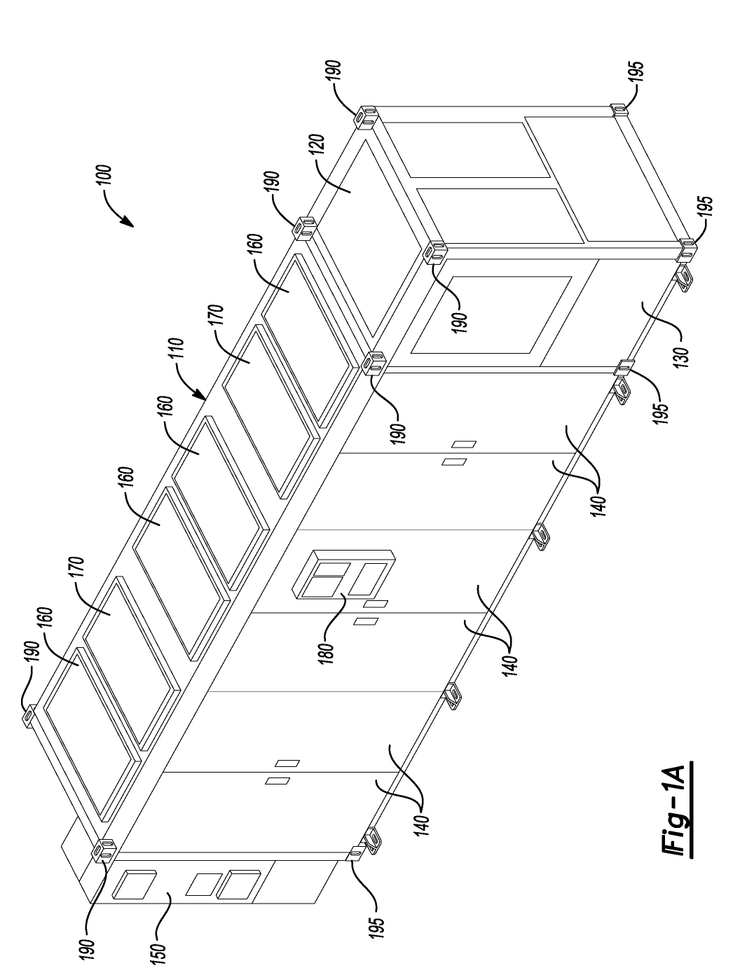

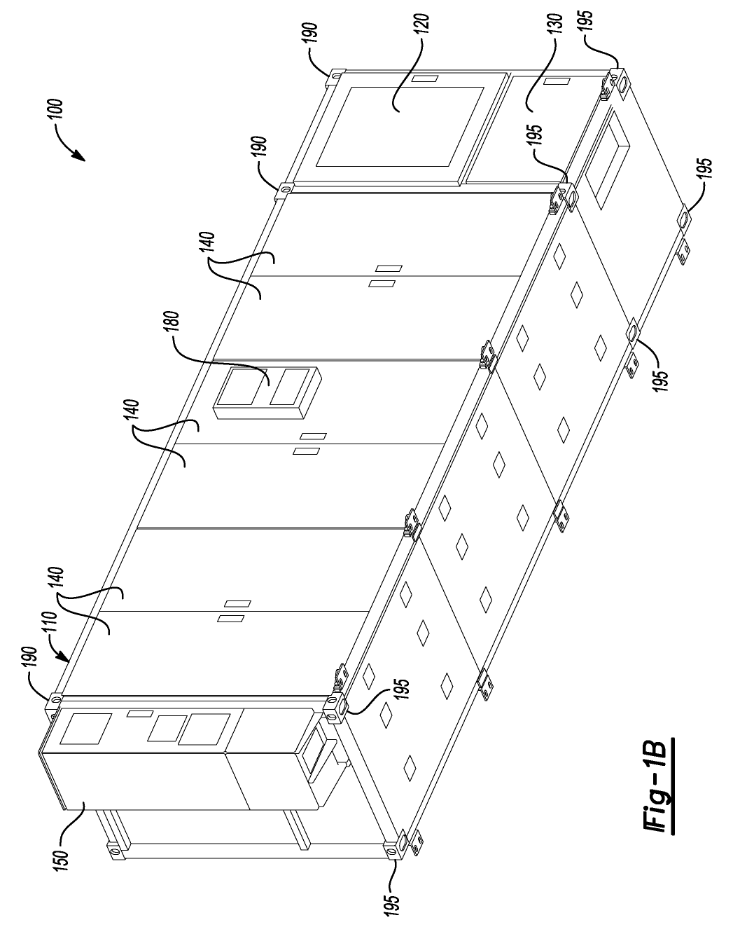

Referring to the drawings, wherein like reference numbers refer to the same or like components in the several Figures. FIG. 1A schematically illustrates an isometric top view of a modular energy storage system 100 including an energy storage system enclosure 110.

The energy storage system enclosure 110 includes a chiller compartment 120, an alternating current (AC) box 130, a plurality of battery compartments 140, a direct current (DC) box 150, deflagration panels 160, passive vents 170, and heating, ventilation, and cooling (HVAC) controls 180, top corner castings 190, and bottom corner castings 195.

FIG. 1B schematically illustrates an isometric bottom view of a modular energy system 100 including an energy system enclosure 110.

The energy system storage enclosure 110 includes a chiller compartment 120, an alternating current (AC) box 130, a plurality of battery compartments 140, a direct current (DC) box 150, and heating, ventilation, and cooling (HVAC) controls 180, top corner castings 190, and bottom corner castings 195.

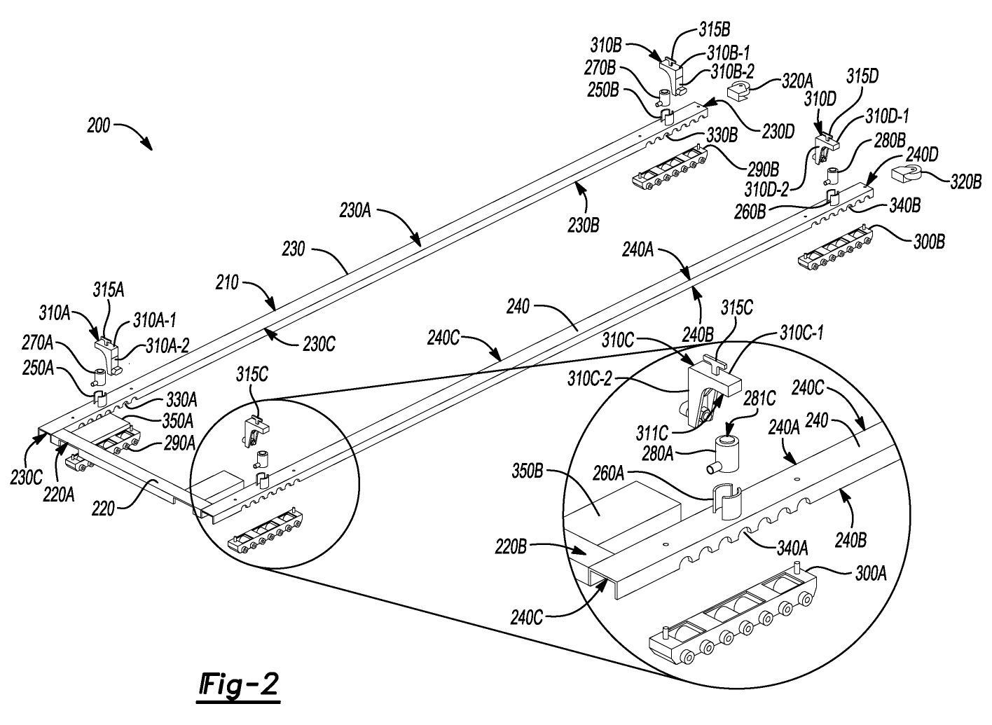

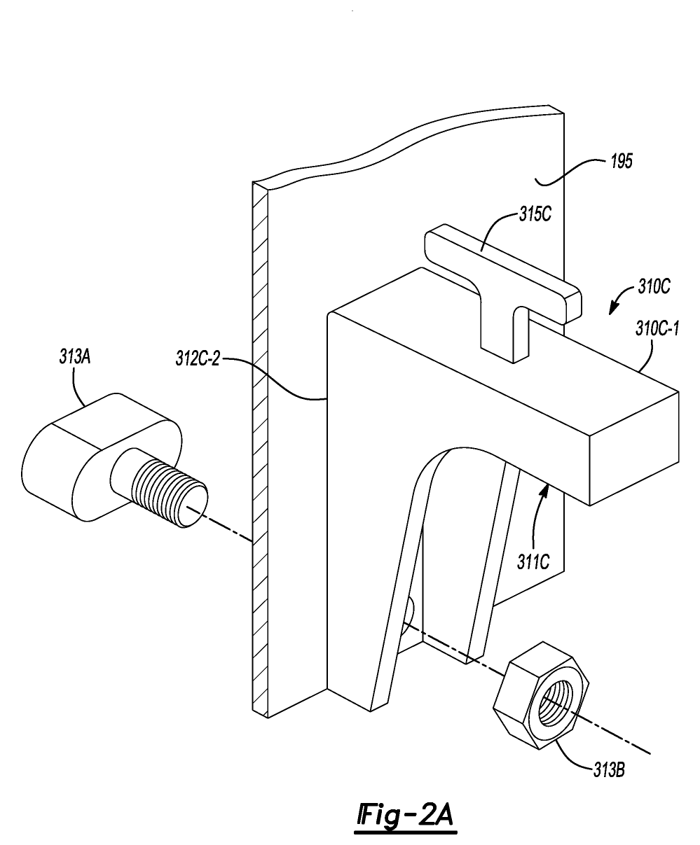

As schematically illustrated in FIG. 2, a loading/unloading system 200 for an energy storage system enclosure 100 includes a skate channel weldment 210 and a plurality of jack lugs 220.

The skate channel weldment 210 includes a front portion 220 having a first end portion 220A and a second end portion 220B, a first side portion 230, and a second side portion 240.

The first side portion 230 includes a first top side 230A, a first bottom side 230B, a first front end 230C, and a first rear end 230D. The first front end 230C of the first side portion 230 is arranged adjacent to the first end portion 220A of the front portion 220 of the skate channel weldment 210.

The second side portion 240 includes a second top side 240A, a second bottom side 240B, a second front end 240C, and a second rear end 240D. The second front end 240Cof the second side portion 240 is arranged adjacent to the second end portion 220B of the front portion 220 of the skate channel weldment 210.

A first plurality of jack mounts 250A, 250B including a first jack mount 250A and a second jack mount 250B are arranged adjacent to the first top side 230A of the first side portion 230 of the skate channel weldment 210.

A second plurality of jack mounts 260A, 260B including a third jack mount 260A and a fourth jack mount 260B are arranged adjacent to the second top side 240A of the second side portion 240 of the skate channel weldment 210.

A first plurality of hydraulic jacks 270A, 270B are arranged adjacent to opposite ends, i.e., the first front end 230C and the first rear end 230D, of the first side portion 230 of the skate channel weldment 210. Each of the first plurality of hydraulic jacks 270A, 270B are disposed within the first plurality of jack mounts 250A, 250B respectively.

A second plurality of hydraulic jacks 280A, 280B are arranged adjacent to opposite ends, i.e., the second front end 240C and the second rear end 240D, of the second side portion 240 of the skate channel weldment 210. Each of the second plurality of hydraulic jacks 280A, 280B are disposed within the second plurality of jack mounts 260A, 260B respectively.

A first plurality of skate assemblies 290A, 290B is arranged adjacent to the first bottom side 230B of the first side portion 230, and a second plurality of skate assemblies 300A, 300B is arranged adjacent to the second bottom side 240B of the second side portion 240.

A plurality of jack lugs 310 are arranged adjacent to each of the first plurality of hydraulic jacks 270A, 270B and the second plurality of hydraulic jacks 280A, 280B.

As illustrated in FIG. 2A, each of the plurality of jack lugs 310A, 310B, 310C, 310D include a jack resting portion 310A-1, 310B-1, 310C-b, 310D-1, and an enclosure attachment portion 310A-2, 310-B-2, 310C-2, 310D-2.

A lifting or handle portion 311A, 311B, 311C, 311D, for example but not limited to a T-shaped handle, may extend respectively from the jack resting portion 310A-1, 310B-1, 310C-1, 310D-1 of each of the plurality of jack lugs 310A, 310 B, 310C, 310D, to assist in lifting each of the plurality of jack lugs 310A, 310B, 310C, 310D.

Each of the enclosure attachment portions 310A-2, 310B-2, 310C-2, 310D-2 includes an opening for receiving a fastener 313 to attach each of the plurality of jack lugs 310A, 310B, 310C, 310D to respective bottom corner castings 195 of the energy storage system enclosure 110.

Referring back to FIG. 2, the front portion 220, the first side portion 230, and the second side portion 240 of the skate channel weldment 210 define a U-shape.

Each of the front portion 220, the first side portion 230, and the second side portion 240 include a U-channel.

The loading/unloading system 200 further includes a first wheel assembly 320A and a second wheel assembly 320B. The first wheel assembly 320A is arranged at the first rear end 230D of the first side portion 230 of the skate channel weldment 210. The second wheel assembly 320Bis arranged at the second rear end 240D of the second side portion 240 of the skate channel weldment 210.

A first plurality of skate mounts 330A, 330B is formed in the first bottom side 230B of the first side portion 230 of the skate channel weldment 210. A second plurality of skate mounts 340A, 340B is formed in the second bottom side 240B of the second side portion 240 of the skate channel weldment 210.

Each of the first plurality of skate assemblies 290A, 290B is arranged within a respective one of the first plurality of skate mounts 330A, 330B. Each of the second plurality of skate assemblies 300A, 300B is arranged within a respective one of the second plurality of skate mounts 340A, 340B.

A first guiding channel 350A extends from the first end portion 220A of the front portion 220 of the skate channel weldment 210, and a second guiding channel extends 350B from the second end portion 220B of the front portion 220 of the skate channel weldment 210.

The first guiding channel 350A is parallel to the first side portion 230 of the skate channel weldment 210 and arranged adjacent to a first inside surface 230C of the first side portion 230 of the skate channel weldment 210.

The second guiding channel 350B is arranged adjacent to a second inside surface 240C of the second side portion 240 of the skate channel weldment 210.

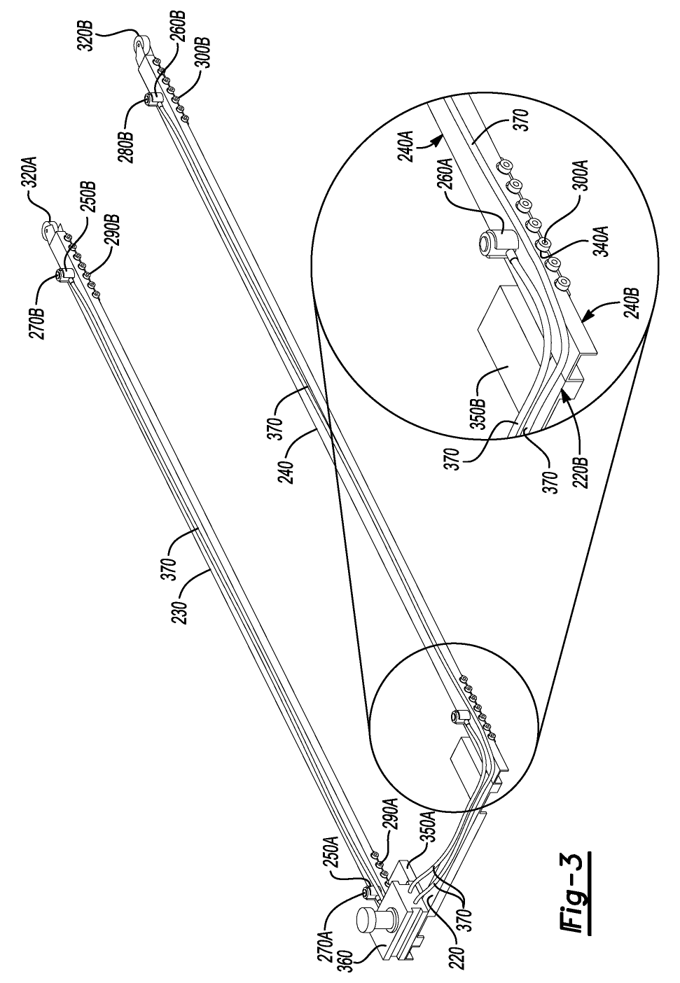

As schematically illustrated in FIG. 3 with continued reference to FIG. 2, a hydraulic pump system 360 is in hydraulic communication with each of the first plurality of hydraulic jacks 270A, 270B and each of the second plurality of hydraulic jacks 280A, 280B via a plurality of hydraulic lines 370.

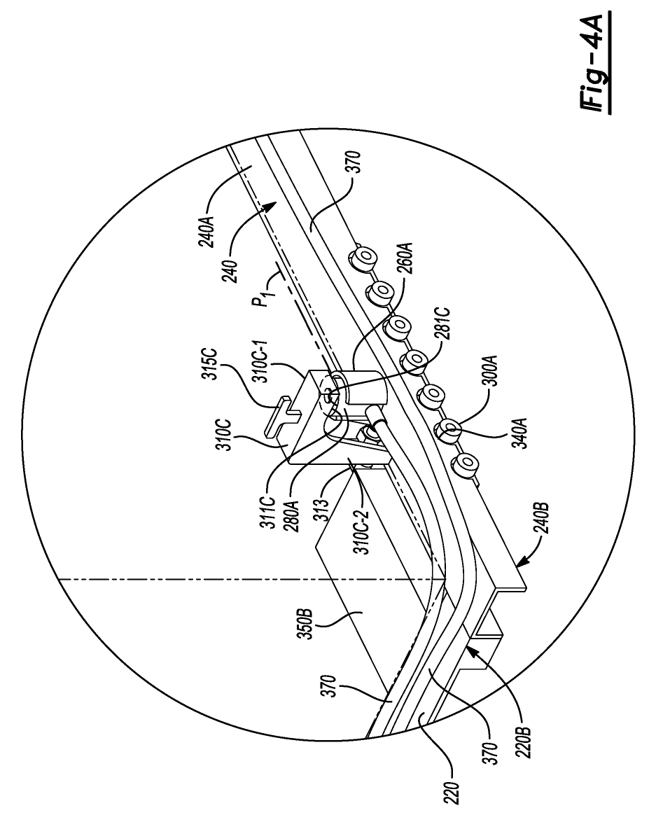

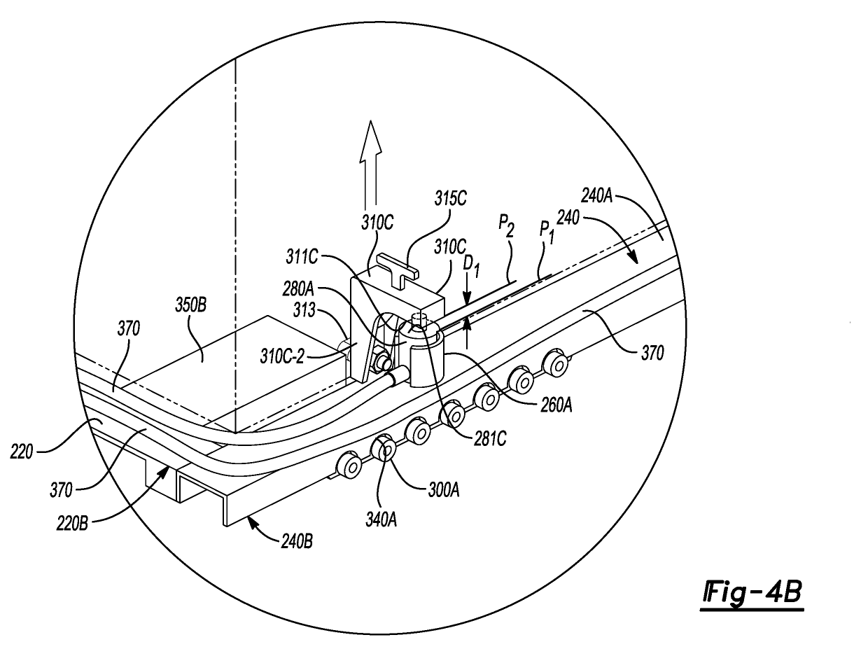

As schematically illustrated in FIG. 4A and FIG. 4B, the hydraulic pump system 360 is operable to move the first plurality of hydraulic jacks and the second plurality of hydraulic jacks between a retracted position to an extended position.

As illustrated in FIG. 4A, when the first plurality of hydraulic jacks 270A, 270B and the second plurality of hydraulic jacks 280A, 280B are in the retracted position P1, the loading/unloading system 200 is slidable beneath the plurality of jack lugs 310A, 310B, 310C, 310D attached to the bottom corner castings 195 of the energy storage system enclosure 110.

In the retracted position P1, bottom surfaces 311A, 311B, 311C, 311D of the plurality of jack lugs 310A, 310B, 310C, 310D are adjacent to and rests upon top surfaces 271A, 271B, 281A, 281B of the first plurality of hydraulic jacks 270A, 270B, and the second plurality of hydraulic of hydraulic jacks 280A, 280B respectively.

As illustrated in FIG. 4B, when the first plurality of hydraulic jacks 270A, 270B and the second plurality of hydraulic jacks 280A, 280B are in the extended position P2, the first plurality of hydraulic jacks 270A, 270B and the second plurality of hydraulic jacks 280A, 280B engage their respective jack lugs 310A, 310B, 310C, 310D to lift the energy storage system enclosure vertically from the retracted position P1 to the extended position P2 a predetermined distance D1.

In the extended position P2, bottom surfaces 311A, 311B, 311C, 311D of the plurality of jack lugs 310A, 310B, 310C, 310D are spaced apart the predetermined distance D1 from the top surfaces 271A, 271B, 281A, 281B of the first plurality of hydraulic jacks 270A, 270B, and the second plurality of hydraulic jacks 280A, 280B respectively.

Once the energy storage system enclosure 110 is lifted, the energy storage system enclosure 110, resting on the loading/unloading system 200, is moveable into a standard shipping container.

According to one aspect of the disclosure, a loading/unloading system 200 for an energy storage system enclosure 110 includes a skate channel weldment 210 having a U-shape, a pair of guide wheels 320A, 320B arranged at a rear end 230D, 240D of the skate channel weldment 210, a plurality of jack mounts 250A, 250B, 260A, 260B arranged adjacent to a top side 230A, 230B of the skate channel weldment 210, a plurality of hydraulic jacks 270A, 270B, 280A, 280B arranged within the plurality of jack mounts 250A, 250B, 260A, 260B; a plurality of skate assemblies 290A, 290B, 300A, 300B arranged adjacent to a bottom side 230B, 240B of the skate channel weldment 210, and a plurality of jack lugs 310A, 310B, 310C, 310D.

The plurality of hydraulic jacks 270A, 270B, 280A, 280B are moveable between a retracted position and an extended position.

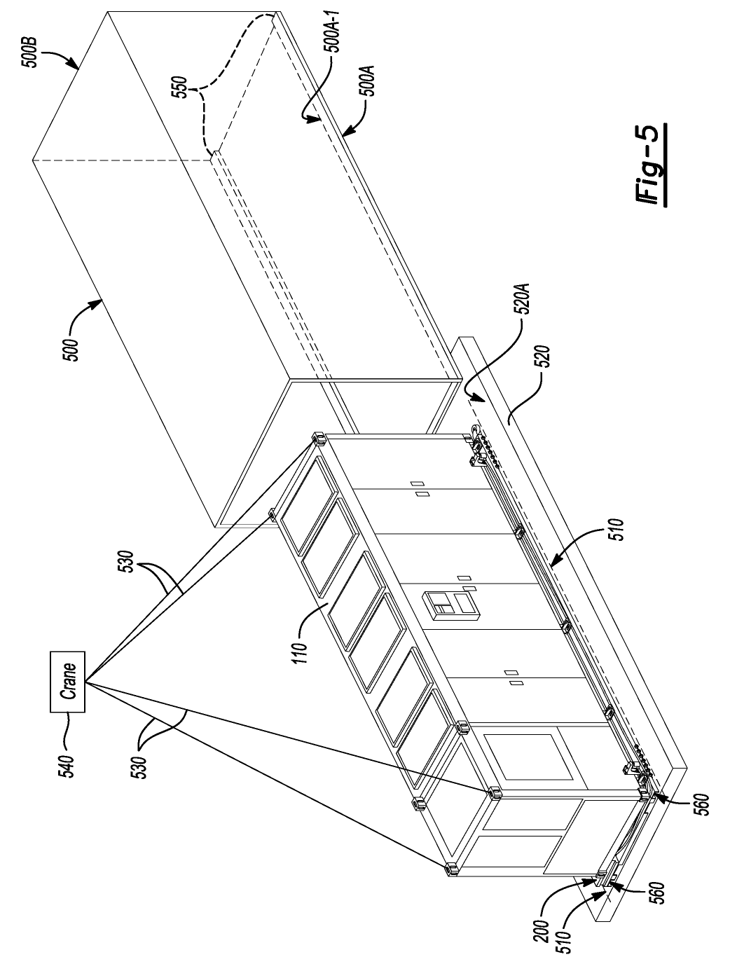

As illustrated in FIG. 5, a loading/unloading system 200 for loading/unloading an energy storage system enclosure 110 to/from a shipping container 500 that includes a floor 500A having a top side 500A-1, a front end 500B, and two rectangular steel channels 550.

A top surface 520A of the platform 520 may be adjusted to be coplanar with the floor 500A of the shipping container 500.

The loading/unloading system 200 is aligned between markings 510 on a platform 520.

A plurality of jack lugs 310A, 310B, 310C, 310D are attached to bottom corner castings 195 of the energy storage system enclosure 210.

A crane 540 is used to lift the energy storage system enclosure 110 via, for example but not limited to a plurality of lifting lugs (not shown) attached to a plurality of steel cables 530. The plurality of lifting lugs is attached to energy storage system enclosure 110 via a plurality of top corner castings 190.

The crane 540 is operable to lift the energy storage system enclosure 110 and place the energy storage system enclosure 110 onto the loading/unloading system 200 such that each of the plurality of jack lugs 310A, 310B, 310C, 310D rests respectively on the plurality of hydraulic jacks 270A, 270B, 280A, 280B.

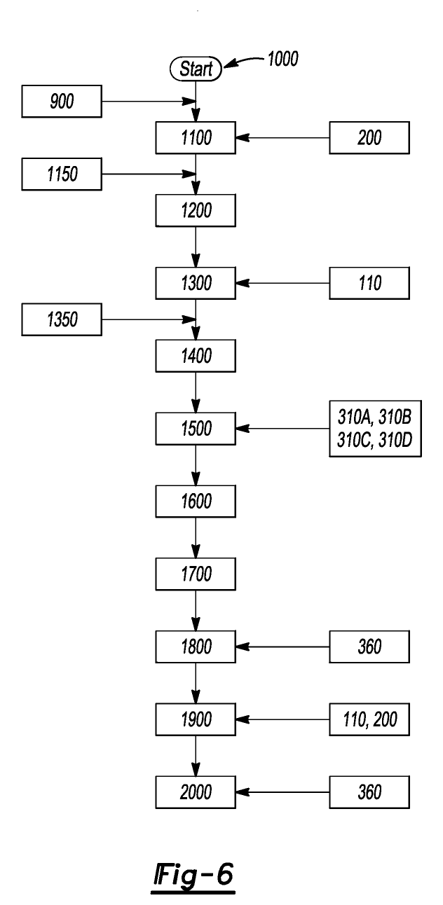

Accordingly, as illustrated in FIG. 6 with continued reference to FIG. 2, FIG. 4A, FIG. 4B, and FIG. 5, a method 1000 of loading/unloading an energy storage system enclosure 110 into/form a shipping container 500 includes: providing 1100 a loading/unloading system 200 for an energy storage system enclosure 110; aligning 1200 the loading/unloading system 200 within markings 510 on a platform 520 adjacent to a shipping container floor 500A; lifting 1300 the energy storage system enclosure 110 via a plurality of lifting lugs (not shown), each of which is attached to a respective one of a plurality of top corner castings 190 attached to the energy storage system enclosure 110; positioning 1400 the energy storage system enclosure 110 above the loading/unloading system 200; attaching 1500 each of the plurality of jack lugs 310A, 310B, 310C, 310D to a respective one of a plurality of bottom corner castings 195 attached to the energy storage system enclosure 110; adjusting 1600 the loading/unloading system such that each of the plurality of jack lugs 310A, 310B, 310C, 310D is positioned above a respective one of the plurality of hydraulic jacks 270A, 270B, 280A, 280B; lowering 1700 the energy storage system enclosure 110 onto the loading/unloading system 200; activating 1800 a hydraulic pump system 360 to engage the plurality of hydraulic jacks 270A, 270B, 280A, 280B to raise the energy storage system enclosure 110 above the platform 520; moving 1900 the loading/unloading system 200, including the energy storage system enclosure 110, forward toward a front 500B of the shipping container 500 until the energy storage system enclosure 110 is centered within the shipping container 500; and activating 2000 the hydraulic pump system to disengage the plurality of hydraulic jacks 270A, 270B, 280A, 280B to lower the energy storage system enclosure 110 onto dunnage (not shown) on the shipping container floor 500A within the shipping container 500.

The loading/unloading system includes a skate channel weldment 210 having a U-shape, a pair of guide wheels 320A, 320B arranged at a rear end 230D, 240D of the skate channel weldment 210, a plurality of jack mounts 250A, 250B, 260A, 260B arranged adjacent to a top side 230A, 240A of the skate channel weldment 210, a plurality of hydraulic jacks 270A, 270B, 280A, 280B arranged within the plurality of jack mounts 250A, 250B, 260A, 260B, a plurality of skate assemblies 290A, 290B, 300A, 300B arranged adjacent to a bottom side 230B, 240B of the skate channel weldment 210, and a plurality of jack lugs 310A, 310B, 310C, 310D.

Each of the plurality of jack lugs 310A, 310B, 310C, 310D respectively includes a jack resting portion 310A-1, 310B-1, 310C-1, 310D-1, and an enclosure attachment portion 310A-2, 310B-2, 310C-2, 310D-2.

Lifting 1300 the energy storage system enclosure 110 includes attaching 1350 steel cables 530 to the lifting lugs 190, and lifting the energy storage system enclosure 110 via the steel cables 530 using a crane 540.

The method 1000 of loading/unloading the energy storage system enclosure 110 further includes leveling 1150 a top surface 520A of the platform 520 to be coplanar with a top surface 500A-1 of a floor 500A of the shipping container 500.

The method 1000 of loading/unloading the energy storage system enclosure 110 further includes positioning 900 two rectangular steel channels 550 within the shipping container 500, such that each of the pair guide wheels 320A, 320B engages with a respective one of the two rectangular steel channels 550 to guide the loading/unloading system 200 within the shipping container 500.

The pair of guide wheels 320A, 320B are configured to guide the loading/unloading system 200 along the two rectangular steel channels 550 within the shipping container 500 when the loading/unloading system 200, including the energy storage system enclosure 110, is moving forward toward the front 500B of the shipping container 500.

The hydraulic pump system 360 is activated 1800 to engage the plurality of hydraulic jacks 270A, 270B, 280A, 280B to raise the energy storage system enclosure up to 15 millimeters above the top surface 520A of the platform 520.

According to one aspect of the disclosure, the loading/unloading system 200, including the energy storage system enclosure 110, is moved and/or removed from the shipping container 500 using a forklift (not shown) inserted into openings 560 in the first side portion 230 and the second side portion 240 of the skate channel weldment 210 of the loading/unloading system 200.

According to one aspect of the disclosure, the plurality of jack lugs 310A, 310B, 310C, 310D may remain attached to the energy storage system enclosure 110 during shipping.

According to one aspect of the disclosure, the plurality of jack lugs 310A, 310B, 310C, 310D may be removed from the energy storage system enclosure 110 prior to shipping.

By providing a loading/unloading system that facilitates the loading and unloading of a modular energy storage system enclosure having increased storage capacity to and from a standard shipping container for transport via ocean freight, utilization of more expensive methods of transport including, for example, non-standard open top and/or flat rack shipping containers, both of which are more expensive and less readily available, may be minimized and/or avoided.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other examples for carrying out the present teachings have been described in detail, various alternative designs and aspects of the disclosure exist for practicing the present teachings defined in the appended claims.

What is claimed is:

1. A loading/unloading system for an energy storage system enclosure comprising:
a skate channel weldment having a first side portion and a second side portion;
a first plurality of hydraulic jacks, wherein each of the first plurality of hydraulic jacks is arranged adjacent to opposite ends of the first side portion of the skate channel weldment;
a second plurality of hydraulic jacks, wherein each of the second plurality of hydraulic jacks is arranged adjacent to opposite ends of the second side portion of the skate channel weldment; and
a hydraulic pump system in hydraulic communication with each of the first plurality of hydraulic jacks and each of the second plurality of hydraulic jacks, wherein the hydraulic pump system is operable to move each of the first plurality of hydraulic jacks and each of the second plurality of hydraulic jacks between a retracted position and an extended position.

2. The loading/unloading system as recited in claim 1, wherein the skate channel weldment further includes:
a front portion having a first end and a second end;
a first side portion having a first top side, a first bottom side, a first front end, and a first rear end, wherein the first front end of the first side portion is arranged adjacent to the first end of the front portion;
a second side portion having a second top side, a second bottom side, a second front end, and a second rear end, wherein the second front end of the second side portion is arranged adjacent to the second end of the front portion;
a first plurality of jack mounts including a first jack mount and a second jack mount arranged adjacent to the first top side of the first side portion;
a second plurality of jack mounts including a third jack mount and a fourth jack mount arranged adjacent to the second top side of the second side portion;
a first plurality of hydraulic jacks disposed within the first plurality of jack mounts;
a second plurality of hydraulic jacks disposed within the second plurality of jack mounts;
a first plurality of skate assemblies arranged adjacent to the first bottom side of the first side portion; and
a second plurality of skate assemblies arranged adjacent to the second bottom side of the second side portion; and
a plurality of jack lugs, wherein each of the plurality of jack lugs includes:
a jack resting portion; and
an enclosure attachment portion.

3. The loading/unloading system as recited in claim 2, wherein the front portion, the first side portion, and the second side portion of the skate channel weldment define a U-shape.

4. The loading/unloading system as recited in claim 3, wherein each of the front portion, the first side portion, and the second side portion includes a U-channel.

5. The loading/unloading system as recited in claim 4, further including:
a first wheel assembly arranged at the first rear end of the first side portion; and
a second wheel assembly arranged at the second rear end of the second side portion.

6. The loading/unloading system as recited in claim 5, further including:
a first plurality of skate mounts formed in the first bottom side of the first side portion, wherein each of the first plurality of skate assemblies is arranged within a respective one of the first plurality of skate mounts; and
a second plurality of skate mounts formed in the second bottom side of the second side portion, wherein each of the second plurality of skate assemblies is arranged within a respective one of the second plurality of skate mounts.

7. The loading/unloading system as recited in claim 6, further including:
a first guiding channel extending from the front portion, wherein the first guiding channel is arranged adjacent to a first inside surface of the first side portion; and
a second guiding channel extending from the front portion, wherein the second guiding channel is arranged adjacent to a second inside surface of the second side portion.

8. The loading/unloading system as recited in claim 7, wherein each of the plurality of jack lugs includes an opening arranged in the enclosure attachment portion for attachment to a bottom corner casting of the energy storage system enclosure via a fastener.

9. The loading/unloading system as recited in claim 8, wherein the hydraulic pump system is operable to raise the first plurality of hydraulic jacks and the second plurality of hydraulic jacks from the retracted position to the extended position, and lower the first plurality of hydraulic jacks from the extended position to the retracted position.

10. A loading/unloading system for an energy storage system enclosure comprising:
a skate channel weldment having a U-shape;
a pair of guide wheels arranged at a rear end of the skate channel weldment;
a plurality of jack mounts arranged adjacent to a top side of the skate channel weldment;
a plurality of hydraulic jacks arranged within the plurality of jack mounts;
a plurality of skate assemblies arranged adjacent to a bottom side of the skate channel weldment; and
a plurality of jack lugs, wherein each of the plurality of jack lugs includes:
a jack resting portion; and
an enclosure attachment portion, wherein the plurality of hydraulic jacks is moveable between a retracted position and an extended position.

11. A method of loading/unloading an energy storage system enclosure comprising:
providing a loading/unloading system for an energy storage system enclosure, the loading/unloading system including:
a skate channel weldment having a U-shape, the skate channel weldment including a first side portion and a second side portion;
a plurality of hydraulic jacks, wherein each of the plurality of hydraulic jacks is arranged adjacent to opposing ends of the first side portion and opposing ends of the second side portion of the skate channel weldment; and
a hydraulic pump system in hydraulic communication with each of the plurality of hydraulic jacks, wherein the hydraulic pump system is operable to move each of the plurality of hydraulic jacks between a retracted position and an extended position; and
activating the hydraulic pump system to raise and lower the energy storage system enclosure.

12. The method as recited in claim 11, wherein the loading/unloading system further includes:
a pair of guide wheels arranged at a rear end of the skate channel weldment;
a plurality of jack mounts arranged adjacent to a top side of the skate channel weldment;
a plurality of hydraulic jacks arranged within the plurality of jack mounts;
a plurality of skate assemblies arranged adjacent to a bottom side of the skate channel weldment; and
a plurality of jack lugs, wherein each of the plurality of jack lugs includes:
a jack resting portion; and
an enclosure attachment portion, and
wherein the method further includes:
aligning the loading/unloading system within markings on a platform adjacent to a shipping container floor;
lifting the energy storage system enclosure via a plurality of lifting lugs, each of which is attached to a respective one of a plurality of top corner castings attached to the energy storage system enclosure;
positioning the energy storage system enclosure above the loading/unloading system;
attaching each of the plurality of jack lugs to a respective one of a plurality of bottom corner castings attached to the energy storage system enclosure;
adjusting the loading/unloading system such that each of the plurality of jack lugs is positioned above a respective one of the plurality of hydraulic jacks;
lowering the energy storage system enclosure onto the loading/unloading system;
activating the hydraulic pump system to engage the plurality of hydraulic jacks to raise the energy storage system enclosure above the platform;
moving the loading/unloading system, including the energy storage system enclosure, forward toward a front of the shipping container until the energy storage system enclosure is centered within the shipping container; and
activating the hydraulic pump system to disengage the plurality of hydraulic jacks to lower the energy storage system enclosure onto dunnage within the shipping container.

13. The method as recited in claim 12, wherein lifting the energy storage system enclosure includes attaching steel cables to the lifting lugs, and lifting the energy storage system enclosure via the steel cables using a crane.

14. The method as recited in claim 12, further including leveling a top surface of the platform to be coplanar with a top surface of a floor of the shipping container.

15. The method as recited in claim 12, wherein the pair of guide wheels are configured to guide the loading/unloading system within the shipping container when the loading/unloading system, including the energy storage system enclosure, is moving forward toward the front of the shipping container.

16. The method as recited in claim 15, further including positioning two rectangular steel channels within the shipping container, wherein each of the pair guide wheels engages with a respective one of the two rectangular steel channels to guide the loading/unloading system within the shipping container.

17. The method as recited in claim 12, wherein the hydraulic pump system is activated to engage the plurality of hydraulic jacks to raise the energy storage system enclosure up to 15 millimeters above a top surface of the platform.

18. The method as recited in claim 12, wherein the loading/unloading system, including the energy storage system enclosure, is moved using a forklift.

19. The method as recited in claim 12, wherein the plurality of jack lugs remains attached to the energy storage system enclosure during shipping.

20. The method as recited in claim 12, wherein the plurality of jack lugs is removed from the energy storage system enclosure prior to shipping.
